(19) United States
(12) Patent Application Publication
(10) Pub. No.: US 2022/0076307 A1
(43) Pub. Date: Mar. 10, 2022

(54) CUSTOMISABLE DASHBOARD FOR THE TRANSACTIONAL, E-COMMERCE PORTAL FOR PRODUCTS AND SERVICES IN A SECURED ENVIRONMENT

(71) Applicant: GNANAPRAKASH A, Chennai (IN)

(72) Inventor: GNANAPRAKASH A, Chennai (IN)

(21) Appl. No.: 17/026,180

(22) Filed: Sep. 19, 2020

(30) Foreign Application Priority Data
Sep. 4, 2020 (IN) 202041038138

(51) Int. Cl. G06Q 30/06; G06Q 20/02; G06Q 30/00; G06Q 50/26; G06Q 10/08; G06F 9/451; G05D 1/02

(52) U.S. Cl. CPC G06Q 30/0605; G06Q 20/027; G06Q 30/0625; G06Q 30/0639; G06Q 30/018; G06F 3/0482; G06Q 10/083; G06Q 30/0641; G06F 9/451; G05D 1/0278; G05D 2201/0217; G06Q 50/265

(57) ABSTRACT

A system and method for creating customisable dashboard for the transactional, e-commerce portal in a secured environment enable the buyers and sellers of goods and services to connect easily to conduct businesses through online, thereby achieving the objective of simple and transparent manner of exchanging goods and services without the intervention of any third party. The customisable dashboard module is configured in association with an ecommerce platform for searching the existing product or service and adding a new item in their dashboard by the buyers and sellers. The said platform ensures only privacy-focused, limited amount of data only collected from the first user by the platform enabler, and from the second user by the first user. The e-commerce platform is also equipped to handle the technically advanced features like ‘drone delivery’ and delivery through the mechanised walking robots to the second user from the first user. Providing robust e-commerce features for the buyers and sellers of goods and services, this platform guarantees customer-centric, decentralized enterprises to thrive and flourish.

### TECHNICAL FIELD OF THE INVENTION

The present invention relates to buying and selling of goods in general, and more particularly creating customisable dashboard in an e-commerce portal for the buyers and sellers to organize their dashboard display system based on their choice of goods or services they want to sell or buy. The said e-commerce platform can be accessed from all types of internet-enabled communication devices like Smart phones, Desktop Computers, Laptop Computers and Digital Tablets.

### BACKGROUND OF THE INVENTION

The age of ‘Internet’ has paved the way people interacting and collaborating in unimaginable ways. The emergence of e-commerce platforms are certainly one of the trends came into existence due to the advent of internet. For the past decades so many e-commerce applications have been developed to connect the buyers and sellers. Most of these e-commerce sites have been connecting thousands of merchants with millions of people all over the world. Still, the buyers and sellers can't have an option to view their e-commerce activities through the unified dashboard system. Besides, almost all the e-commerce platforms give opportunity for the merchants to offer only the products and not services. To avail services, the people have to look for several other sites. Moreover, the existing e-commerce sites are also not offering simplified dashboard system for the buyers and sellers to view the status of the goods or services exchanged through the e-commerce platform.

Due to this factor, the buyers (largest group of users) have to scroll, sift, sort and search a huge amount of data to get the desired product. Before reaching their desired product, the users have to watch several other ‘unnecessary’ products and advertisements. In doing so, their system is clogged with loads of unwanted data and it also consumes their valuable time. Apart from its financial cost, these kinds of unwanted data also decrease the speed of their browsing device, irrespective of the network speed. To Address the problem, we have proposed a novel solution. The idea of the inventor is to create a unified e-commerce platform for the products and services. The said platform offers a convenient option for all the stakeholders—merchants, service providers and buyers—to arrange their dashboard in an organised manner. The sellers and Buyers of goods or services shall easily configure their dashboard. This method will allow only a gradual flow of information back and forth, making it more data-efficient architecture.

### RELATED APPLICATIONS

Reference has been made to the patent title “Apparatus and method for processing a multimedia commerce service with the application number U.S. Pat. No. 9,679,332B2. According to their field of invention “This invention relates to multimedia commerce delivery to end-users, and more specifically to delivery of a branded commerce environment to end-user devices, such as a ‘smart TV.’

Further reference has been made to the patent title” Method, apparatus, and system for displaying order information with the application number US20150234791A1 [current assignee: Alibaba Group Holding Ltd]. According to their field of invention “The present application relates to a method, an apparatus, and a system for displaying order information in a background display area.

One more reference has been made to the patent title “Method, equipment and server for showing commodity in shopping at network” with the application number CN107220880A. According to their Abstract “Method, equipment and server for showing commodity in shopping at network. The present invention provides a kind of method for being used to show commodity in shopping at network, including: Receive the trigger request of the private page of user; The private page is shown, and directly shows in the private page information of the screening commodity of the user. Directly show screening commodity in individual centre, the commodity that there can be user demand but to be bought without the very first time, which are given, more shows chance, promotes user's purchase.

In terms of scope or its field of invention, these three above-quoted inventions are entirely different from this invention, which guarantees a customizable dashboard for all the users (products and service sellers and buyers).

In the prior art, there is no option available for the first users (sellers; merchant or service providers) can create a customizable dashboard to display the products and services that they offer.

In the prior art, there is no option available for the second users (buyers) can create customisable dashboard to view the products and services as per their ‘preferred choice.’

In the prior art, there is no option available for the first users to add their list of services as such the e-commerce portals are specifically designed to list only the ‘products’ and not ‘services.’

In the prior art, the existing e-commerce platforms are not designed to ensure smooth and sustained flow of required data between the first users and second users.

In the prior art, the existing platforms are not designed for the first user to collect only privacy-focussed data from the second user.

In the prior art, there is no option available for the users (first users and second users) to customise their dashboard.

In the prior art, the existing platforms are not designed to support the technically advanced gps-enabled drone delivery mechanism or robot-assisted direct delivery system.

In the prior, there is no option available for the second user to send their complaints and grievances to the first user through the e-commerce platform.

Based on the foregoing, there is a need exist for the users (sellers; merchant or service provider) can create a customizable dashboard to display the products and services that they offer.

There is a need exists in an ecommerce platform for first users (sellers; merchant or service provider) can create a customizable dashboard to display the products and services that they offer.

There is a need exists in an e-commerce platform, wherein the second users (buyers) can create customisable dashboard to view the products and services as per their ‘preferred choice.’

There is a need exists in an e-commerce platform, wherein an option available for the first users to add also their services.

There is a need exists in an e-commerce platforms to ensure smooth and sustained flow of required data between the first users and second users.

There is a need exists in an e-commerce platform for the first user to collect only privacy-focussed data from the second user.

There is a need exists in an e-commerce platform for the users (first users and second users) to customise their dashboard.

There is a need exists in an ecommerce platforms to support the technically advanced gps-enabled drone delivery mechanism or robot-assisted direct delivery system.

There is a need exists for the second user to send their complaints and grievances to the first user through the e-commerce platform.

### BRIEF SUMMARY OF THE INVENTION

The following summary is provided to facilitate an understanding of some of the innovative features unique to the disclosed embodiment and is not intended to be a full description.

It is, therefore, one aspect of the disclosed embodiment is to provide an option for the users (sellers; merchant or service provider) can create a customizable dashboard to display the products and services that they offer.

It is therefore, one more aspect of the disclosed embodiment is to provide an option in the ecommerce platform for first users (sellers; merchant or service provider) can create a customizable dashboard to display the products and services that they offer.

It is therefore, one more aspect of the disclosed embodiment is to provide an option in an e-commerce platform, wherein the second users (buyers) can create customisable dashboard to view the products and services as per their ‘preferred choice.’

It is therefore, one more aspect of the disclosed embodiment is to create an option in an e-commerce platform, wherein the first users to list their services.

It is therefore, one more aspect of the disclosed embodiment is to design the architecture of the e-commerce platforms to ensure smooth and sustained flow of data between the first users and second users.

It is therefore, one more aspect of the disclosed embodiment is to allow the first user to collect only privacy-focussed data from the second user through this e-commerce platform.

It is therefore, one more aspect of the disclosed embodiment is to provide an option in an e-commerce platform for the users (first users and second users) to customise their dashboard.

It is therefore, one more aspect of the disclosed embodiment is to provide an option in an ecommerce platform to support the technically advanced gps-enabled drone delivery mechanism or robot-assisted direct delivery system.

It is therefore, one more aspect of the disclosed embodiment is to provide an option for the second user to send their complaints and grievances to the first user through the e-commerce platform.

The aforementioned aspects and other objectives and advantages can now be achieved as described herein. A system and method for creating a customised dashboard for the first user and the second users can be done for the purpose of

Easy of doing business with limited amount of data is disclosed herein. The message ‘customised dashboard’ module configured in association with an e-commerce platform with a simplified user interface. The message ‘customized dashboard’ module enables the first and user and second users to design their dashboard based on their choice of goods and services they want to buy or sell. And this will avoid the chaotic display of products and services in an e-commerce platform. A cloud server is required for receiving, processing and sending the data between first user and second users in a secured environment.

### BRIEF DESCRIPTION OF THE DRAWINGS

Example embodiments of the present invention are illustrated by accompanying drawings, wherein:

FIG. 1 illustrates a graphical representation of an e-commerce portals context diagram, in accordance with the disclosed embodiments;

FIG. 2 illustrates a graphical representation of an e-commerce portal's activity diagram, in accordance with the disclosed embodiments;

FIG. 3 illustrates a graphical representation of an e-commerce portal's application server diagram, in accordance with the disclosed embodiments;

FIG. 4 illustrates a graphical representation of an e-commerce portal's system boundaries, in accordance with the disclosed embodiments;

FIG. 5 illustrates a graphical representation of an e-commerce portal's registration to payment gateway system, in accordance with the disclosed embodiments;

FIG. 6 illustrates a graphical representation of an e-commerce portal's product delivery system, in accordance with the disclosed embodiments;

FIG. 7 illustrates a graphical representation of an e-commerce portal's delivery channel architecture, in accordance with the disclosed embodiments;

FIG. 8 illustrates a graphical representation of an e-commerce portal's buyer view of ordering an item to getting it's delivery, in accordance with the disclosed embodiments;

The drawings described herein are for illustration purposes only and are not intended to limit the scope of the present invention in any way.

### DETAILED DESCRIPTION OF THE INVENTION

It is to be understood that the present disclosure is not limited in its application to the details of composition set forth in the following description. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item.

Reference throughout this specification to “one embodiment,” or similar language means that a particular feature, structure, or characteristic described in connection with the embodiment is included in at least one embodiment of the present invention. Thus, appearances of the phrases “one embodiment,” and similar language throughout this specification may, but do not necessarily, all refer to the same embodiment, different embodiments, or component parts of the same or different illustrated invention.

Each statement of an embodiment is to be considered independent of any other statement of an embodiment despite any use of similar or identical language characterizing each embodiment. The wording “one embodiment”, or the like, does not appear at the beginning of every sentence in the specification, is merely a convenience for the reader's clarity. However, it is the intention of this application to incorporate by reference the phrasing “an embodiment,” and the like, at the beginning of every sentence herein where logically possible and appropriate.

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of different features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The attached pictorial documents illustrate a graphical representation of the e-commerce portal's customizable dashboard module for achieving easy way of conducting business by the buyers and sellers in accordance with the disclosed embodiments. The ‘customizable dashboard module’ is configured in association with an e-commerce portal for easily storing and retrieving details about various products and services, as illustrated in the documents with its figures.

The customizable dashboard in an ecommerce portal also permits the users to get an alphabetically arranged list of ‘products and services’.

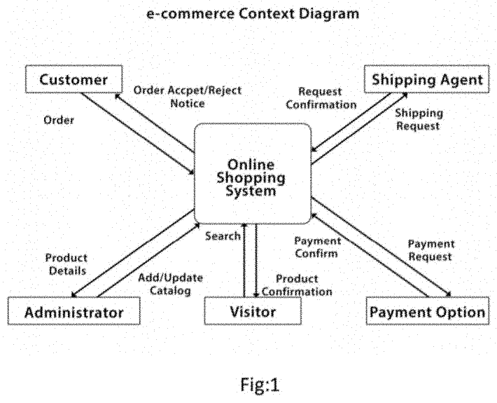

FIGS. 1-8 illustrate a graphical representation of a sequence of screenshots representing “Customisable Dashboard for the transactional, e-commerce portal in a secured and federated environment.”

The aforementioned aspects and other objectives and advantages can now be achieved as described herein. A system and method for creating a customisable dashboard for the transactional, e-commerce portal in a secured and federated environment for the individuals and enterprises is disclosed herein. The customisable dashboard module is configured in association with an e-commerce portal with respect to easily displaying the various products and services by the sellers, placing the order and viewing the status of the order through the dashboard by the buyer and enabling tracking the order by all the stakeholders—platform enablers, buyers and sellers. A dedicated server is required for receiving, processing and sending various kinds of communications between the stakeholders is necessary for smooth functioning of the proposed system.

The customizable dashboard in an ecommerce portal also gives the real-time info about the sold items to the sellers and info about the status of the bought items to the buyers. There is also option available for the buyers and sellers to track the current status of the order from the dashboard. By offering a simplified mechanism to buy and sell products and services, the said e-commerce portal reduces the burden of its customers to a great extent.

The e-commerce portal permits the users to modify their customised dashboard whenever they want it. The sellers can simply add more products/services. In the same fashion, the buyers too can add any number of preferred choices of products and services to view their dashboard accordingly. The registered users only can the order through this e-commerce portal. The unregistered users won't get that privilege. They can simply view the portal and they're not allowed to conduct any business till they register. In this way, the system ensures that the e-commerce services have always been used only by the authentic users.

When a person is searching some product or service, the data loading will happen gradually at the backend. The system is configured to release the data in phased manner. The structured flow of data will enhance the viewing experience of the user. The backend architecture is designed in such a way to include the emerging technologies like Blockchain to verify the provenance of a product. The platform is capable of automate the delivery of a product through conventional human-centric system as well as fully automated drone delivery system. These kinds of technically advanced features make this platform a first-of-its-kind in the e-commerce space.

According to one embodiment of the invention, registered users of the platform shall get a list of readily available service providers in their location once they fill a minimum details of the services they're looking for by means of geo-tagged list of first users which populate to the second users. This is described by an example—When user “A” enters the requirement in the dashboard, he would be getting the complete list of service providers in the particular area where user “A” resides.

Additionally, the user A shall allowed to view the service providers from other areas by simply altering the default location filter.

FIG. 1 illustrates a graphical representation of an e-commerce portals Context diagrams and that shows the views of all the stakeholders—Customers, Shipping agent, Payment gateway system, a non-registered user, E-commerce portal admin with respect to the e-commerce portal environment.

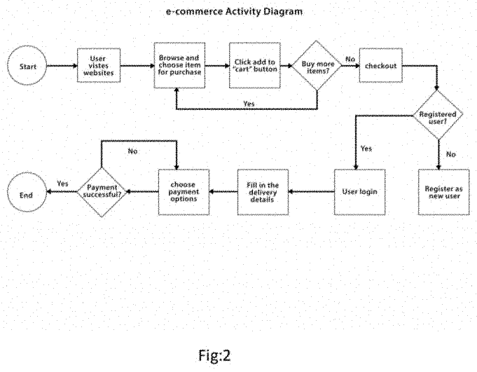

FIG. 2 illustrates a graphical representation of an e-commerce portals activity diagram that describes from starting to end it how an order is executed with various ‘yes’ and ‘no’ possibilities.

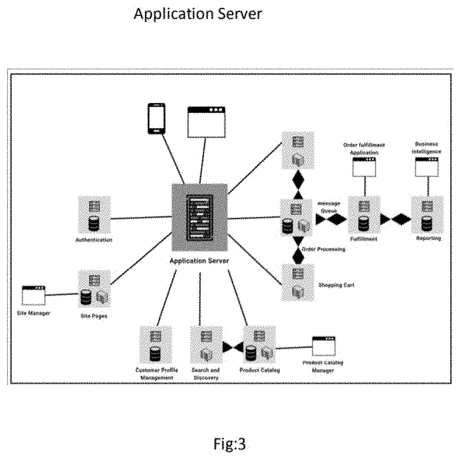

FIG. 3 illustrates a graphical representation of an e-commerce portals application server diagram that describes about the various aspects of the server like authentication site manager site pages customer profile management sachin discovery of a product or service, product catalogue, product catalogue manager, shopping court order, processing message to order fulfillment business intelligence and reporting etc.

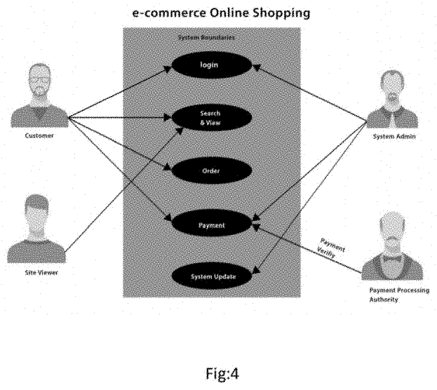

FIG. 4 illustrates the system boundaries diagram that describes the privilege of a customer and register user system admin and the payment processing authority.

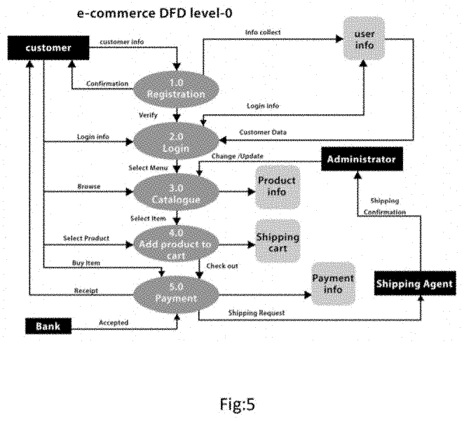

FIG. 5 illustrates the five levels of the e-commerce portals customer review that describe about customer registration, login process, Product catalogue, adding your product to the shopping cart and payment gateway process.

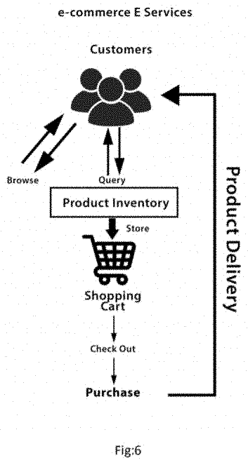

FIG. 6 illustrates the customer's view of the product delivery system in an e-commerce portal.

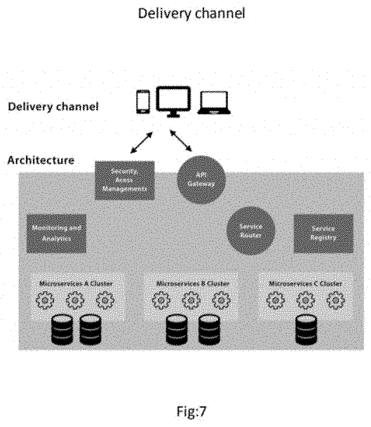

FIG. 7 illustrates the delivery channel architecture with respect to security access management, API Gateway, Monitoring and analytics service router, service registry on top of Micro Services A, B & C.

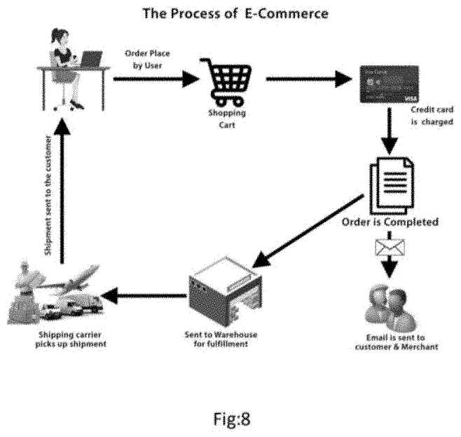

FIG. 8 illustrates the complete cycle of Placing an order, Shopping cart, Payment to the purchased item, Order completion, Email to the customer], Order request sent to the warehouse, Shipping process, and finally the Purchased item delivered to the customer.

It will be appreciated that variations of the above-disclosed and other features and functions, or alternatives thereof, may be desirably combined into many other different systems or applications. Also, unforeseen or unanticipated alternatives, modifications, variations or improvements therein may be subsequently made by those skilled in the art which are also intended to be encompassed by the following claims.

What is claimed is:

1. A method of creating an customisable Dashboard for the transactional, e-commerce portal in a secured environment by a user communication device, between a plurality of users or a group of users, the method comprising:
Listing, by a first user, a variety of products or services in their customized dashboard to sell those listed items to various second users;
Accessing, by a second user, to buy a product or avail a service from the first user(s); wherein the system allows the second user to customize their dashboard;
Enabling the second user to access the payment gateway of the e-commerce platform to complete the purchase of goods or services;
Exchanging, a product or service after the payment, by the first user and the second users through the e-commerce platform Viewing, the real-time status of the product or service, bought or sold, from the dashboard of the e-commerce platform

2. The method according to claim 1, wherein the first user (seller) shall create the customizable dashboard to display and view the products and services that they offer to the second users (buyers) in accordance with the disclosed embodiments;

3. The method according to claim 1, wherein a second user shall search and select at least one product or one service from the first user's list in accordance with the disclosed embodiments.

4. The method according to claim 1, wherein the registered users of the platform shall get a list of readily available service providers in their location once they fill a minimum details of the services they're looking for by means of geo-tagged list of first users which populate to the second users.

5. The method according to claim 1, wherein the first user shall collect limited data from second user,
platform enabler shall collect data from first and second user by maintain legal compliance and following data protection.

6. The method according to claim 1, wherein the platform architecture is designed to empower the first user to deploy their products through the technically advanced gps-enabled drone-delivery and delivery through the mechanized ‘walking robots’ in addition to the conventional human-centric delivery system to the second user in accordance with the disclosed embodiments.

7. The method according to claim 1, wherein all the stakeholders of the platform enabler, first user and second user shall track the status of goods and services at any given point in time in accordance with the disclosed embodiments.

8. The method according to claim 1, wherein the first user to get the proper grievances system to connect the first user through this e-commerce platform in accordance with the disclosed embodiments.

9. The method according to claim 1, wherein the e-commerce platform is configured to allow the first user and the second user to connect with the help of digital communication devices includes but not limited to mobile phones, desktop/laptop/tablet computers to conduct businesses in a highly transparent and convenient manner in accordance with the disclosed embodiments.

10. A computer program product for sending and receiving a message with a subject line by a user communication device, between a plurality of users or a group of users, the method comprising:
Listing, by a first user, a variety of products or services in their customized dashboard to sell those listed items to various second users;
Accessing, by a second user, to buy a product or avail a service from the first user(s);
wherein the system allows the second user to customize their dashboard;
Enabling the second user to access the payment gateway of the e-commerce platform to complete the purchase of goods or services;
Exchanging, a product or service after the payment, by the first user and the second users through the e-commerce platform
Viewing, the real-time status of the product or service, bought or sold, from the dashboard of the e-commerce platform
wherein the selling a product or service, from the user communication device of the first user to the user communication device of a second user or the group of users comprises searching existing ‘product’ or ‘service’ from a database of a e-commerce application server or adding a new ‘item’ in the existing list of available products or services.
wherein buying of a product or service from the first user, can be done by a plurality of users in the group of users,
wherein the user communication device of the second user or at least a second user of the group of users is configured to access the display of products and services displayed by the first user, and
wherein the user communication device of the second user or at least a second user of the group of users is configured to:
receive any number of products or services offered by different first users to execute the ‘buy’ order from the e-commerce platform.
